(19) United States
(12) Patent Application Publication
(10) Pub. No.: US 2010/0282136 A1
(43) Pub. Date: Nov. 11, 2010

(54) PORTABLE VAULT

(76) Inventor: Robert Stanley, Louisville, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/776,389

(22) Filed: May 8, 2010

Related U.S. Application Data
(60) Provisional application No. 61/176,799, filed on May 8, 2009.

(51) Int. Cl. E05G 1/024; E05G 1/026

(52) U.S. Cl. 109/64; 109/79

(57) ABSTRACT

A portable vault assembly is claimed that can provide secure on-site storage, yet may be disassembled easily for removal to a new location when desired. The portable vault includes sections that are independently portable but which feature a combined weight that makes it impossible for the secured container, or vault, to be carried. Further embodiments rely upon features of the site where the vault is assembled to create a secure space, and independent portable vaults may be co-joined to form integrated but separate storage compartments, or one large central storage bin, as desired. Anchoring options, and further theft deterrence features are also disclosed including integration to the work site environment.

### CROSS REFERENCE TO RELATED APPLICATIONS

This invention claims priority from provisional patent application 61/176,799 also titled “Portable Vault” filed on May 8, 2009.

### FIELD OF THE INVENTION

This invention relates generally to a portable vault assembly. More specifically, this invention relates to a portable vault that may be carried in pieces and assembled at a work site where it is desired that the vault be used.

### BACKGROUND OF THE INVENTION

There are many situations where it is desirable to store items in a secure fashion but where there is no existing provisions for doing so. For example, many tradesmen employ a large amount of tools which carry a significant personal investment. These tools are used on jobsites by the tradesmen, and to prevent their theft, they are frequently hauled to and from the jobsite. This can be a tedious and time consuming process, resulting in significant losses in productivity.

Many jobsites are virtually unsecureable because the jobsites themselves cannot be secured in the absence of some person monitoring the site. For example, homes under construction are relatively easily broken into and therefore do not, in their typical state, provide security for expensive tools and equipment. Any site that is easily accessible but will not inherently have observers nearby will present an unsecurable situation in which the potential for theft of tools and equipment is a major concern. Other environments where a portable vault that can be assembled on site would be useful include trade shows, craft fairs, booths within shared retail spaces, and outdoor work sites.

### DESCRIPTION OF RELEVANT ART

U.S. Pat. No. 6,581,424 by Oliver is directed to a portable lock box. A portable lock box includes a box-shaped base member having an open front and top and a box-shaped front closure member having an open back and top. The base and front closure members include complementary horizontal support members and the front closure member is dimensioned to be slidably received through the open front of the base member to form a base assembly that may be filled with ballast. Respective support members define apertures through which elongate fasteners may be extended when aligned so as to couple the front closure member to the base member. A top panel is configured for slidable engagement with the base member so as to cover the open top. The top panel and base member include corresponding bores through which a rod may be extended and locked. Selected items may be stowed for safekeeping in a compartment mounted to an underside of the top panel.

U.S. Pat. No. 5,513,580 by Franks is for a lock box for installation in closets. This invention discloses a lockbox or safe for storing possessions, which can be installed in a closet in a manner that requires opening the lockbox before it can be removed from the closet. This is done by providing one or more extensions (such as side walls, rigid shafts, or end caps) that can be extended outwardly from either or both sides of the lockbox. When retracted, the lockbox has dimensions that allow it to be inserted into the closet through the closet door. After it is positioned on the floor of the closet, the compartment door is opened. This provides access to a mechanism that controls the positioning of the extensions, such as bolts or cotter pins that interact with multiple spaced holes in sliding mechanisms. The extension locking mechanism is unlocked, and the extensions are pushed outwardly until they press against the side walls of the closet. As long as the lockbox remains locked, the extensions pressing against the side walls of the closet will prevent the lockbox from being removed from the closet, unless the door jamb and/or closet walls are destroyed.

U.S. Pat. No. 4,561,362 by Wildmuth is for a moble-immoble safe. The moble-immobile safe is provided with internal removable excess mass which renders the container relatively immobile until the mass is removed. The mass may be, for example, water stored between inner and outer walls of the container or lead shot, steel balls or anti freeze. Normal access to the mass for removal thereof, in order to render the container relatively mobile, is available only after the door of the container has been opened.

U.S. Pat. No. 4,438,606 by Chardon et al. is for a shelter for protecting large-size objects. A shelter for protecting large-size objects, such as open-air machines, cycles, motorcycles, windsurfers, etc. . . . comprises, on its front face, a door giving access to the interior of the shelter and, in its lower part, a flooring on which the object or objects to be protected with beneath the flooring, a compartment in which is housed a heavy mass of which the weight is transferred onto the walls of the shelter, in order to considerably increase the total weight of the shelter and prevent easy handling thereof.

U.S. Pat. No. 4,249,684 by Miller et al. is for a removably anchored box. The removably anchored box provides an easily transportable, general purpose box which may be carried about by hand and then anchored to rails and locked in place. Once the lid is locked on the box, no one without a key can move the box from the anchor rails. The invention is primarily intended as a portable trunk for mounting on a truck; however, it may be used anytime that a box is to be mounted on a chassis, such as a toolbox mounted on a wheeled dolly, a toolroom shelf, or the like, for example.

U.S. Pat. No. 4,664,041 by Wood is for a beach locker. A security lock box for use primarily at beaches having a vertical shaft terminating at its lower end with a screw and an upper end which releasably engages a crank which can be utilized to turn the shaft and by virtue of the screw engage the shaft into the ground, subsequent to which the crank is released from the shaft, the shaft tip inserted through a hole in the lock box, a keeper is inserted on the shaft to retain the lock box, and the lock box is locked, securing within the tip of the shaft so that it may not be rotated and any valuables which have been put into the box.

### SUMMARY OF THE INVENTION

The present invention is directed to providing a portable secure container that can be transported in parts to locations where it is needed. The secure container, or vault, is comprised of several parts which can be assembled to form the container or vault. Some embodiments of the portable vault may have a base, at least one wall extending from the base and a door. Each of these parts has substantial weight by itself but can still be carried by a single person. In some embodiments, when the several sections are assembled together, their combined weight makes it impossible for the secured container, or vault, to be carried. Other embodiments of the portable vault may rely upon features of the site where the vault is assembled to create a secure space. A door on the vault is secured by a lock or locks when closed. The lock or locks may themselves be protected from tampering by the structure of the vault. Once assembled, mechanisms that are only accessible from the inside of the vault, and inaccessible when the door is closed, prevent the vault from being disassembled. In at least one embodiment, apertures in the vault allow the vault to be affixed to the site of the location where the vault will be used. For example, screws or bolts may be used to affix the vault to the floor of a house being built. Other embodiments may have apertures to accommodate a chain for chaining the assembled vault to a post or other objects. Some embodiments may have apertures through a wall of the vault to facilitate anchoring the vault to building wall with screws etc.

Other embodiments of the invention may employ an auger through their base to anchor the portable vault to bare earth or sand. Again, these screws, bolts, chains, augers, etc. are only accessible from the interior of the vault, and are therefore inaccessible when the door of the vault is closed. Attachment of the vault to the floor of the location provides a further dimension of immobility of the vault. The base, walls, and top of the vault are of sufficiently strong material to resist physical deformation from attempts to gain unauthorized access. Also the rigidity and strength of the walls avoids the need for any support framing beyond the shell formed by the wall or walls.

For still other embodiments of this invention, the portable vault may be made at least partially from expanded steel, or similar material, to provide airflow or visibility. Locking means can take a variety of forms.

In yet a further embodiment of the present invention, multiple portable vaults as described above can be co-joined or interlocked together. The vaults may be interlocked in order to provide additional storage space when a single vault is not enough to satisfy the space needs of the specific project. In addition, it is recognized that in many uses, such as a busy construction site, separate work units may need storage space, but it may be desired to keep the storage space of various work units separate from each other. By co-joining multiple vaults, the connected units are rendered even more immobile, while at the same time, separate doors provide for continued segregation of the interior spaces from each other. When it is not necessary to maintain separate and distinct storage sections, interior walls of the co-joined vaults can be removed to create a larger central storage space.

### BRIEF DESCRIPTIONS OF THE DRAWINGS

FIG. 1 shows an exploded assembly view of an embodiment of the invention.

FIG. 2 shows an assembled perspective view of an embodiment of the invention.

FIG. 3 shows a perspective view of a base of an embodiment of the invention.

FIG. 4 shows a perspective view of parts of the bottom of a panel of an embodiment of the invention.

FIG. 5 is a perspective view of an embodiment of the invention partially assembled with two side walls affixed to a base.

FIG. 6 is a side view of a partially assembled embodiment of the invention with a rear wall, a front wall, and a top with door attached in position for assembly.

FIG. 7 is a partial perspective view of a panel of one embodiment of the invention showing a retaining mechanism.

FIG. 8 is a partial perspective view of a cut-away of the retention mechanism in place similar to that shown in FIG. 7.

FIG. 9 is a perspective view of an embodiment of the invention showing the door being removable from a top.

FIG. 10 is a perspective view of an embodiment of the invention with the door propped open to a level position to present a large horizontal surface.

FIG. 11 is a perspective view of an embodiment of the invention with the door propped to a vertical open position and a front panel removed.

FIG. 12 shows a perspective view of parts of the bottom of a panel of an embodiment of the invention.

FIG. 13 is a perspective view of an embodiment of the invention not having its own base, with the door propped to a vertical open position and a front panel removed.

### DETAILED DESCRIPTIONS OF EMBODIMENTS

Assembly of the parts of the portable vault results in a closable shell. Some embodiments of the portable vault have a base, at least one wall extending from the base, and a door providing closable access to the interior. Other embodiments of the portable vault use elements of its assembly site to create an enclosable secure volume. The mechanisms preventing the disassembly of the portable vault are only accessible from the interior of the vault and therefore are inaccessible when the portable vault is locked up. Various embodiments of the portable vault will be discussed below with similar elements being labeled with the same number when appropriate. Generally, embodiments of portable vaults of the present invention allow a vault to be constructed easily from walls that are modularly interconnectable and that do not need framing elements to provide structure. The modular interconnectability of the elements of the portable vault is accomplished without the need for any external tools.

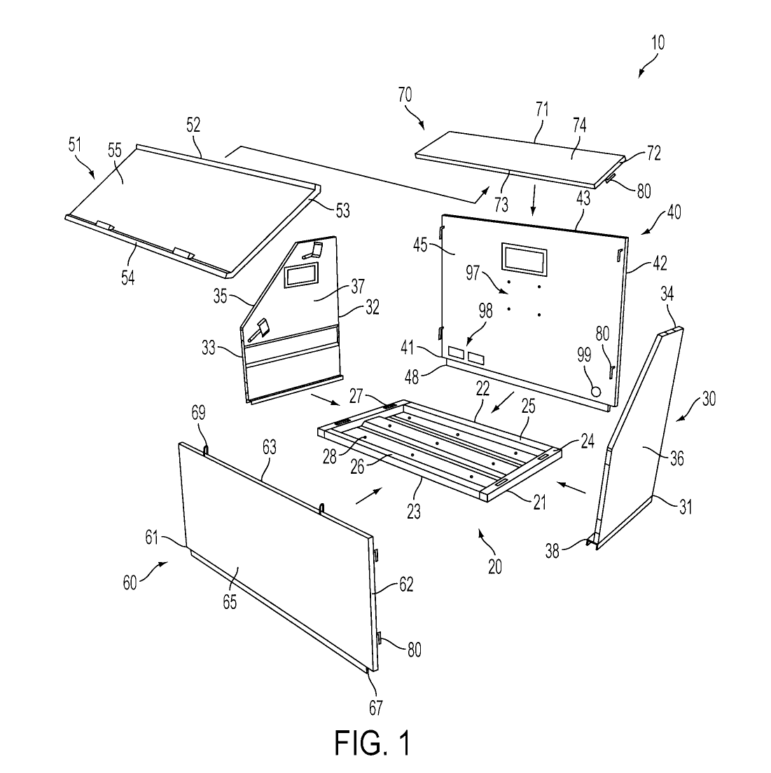

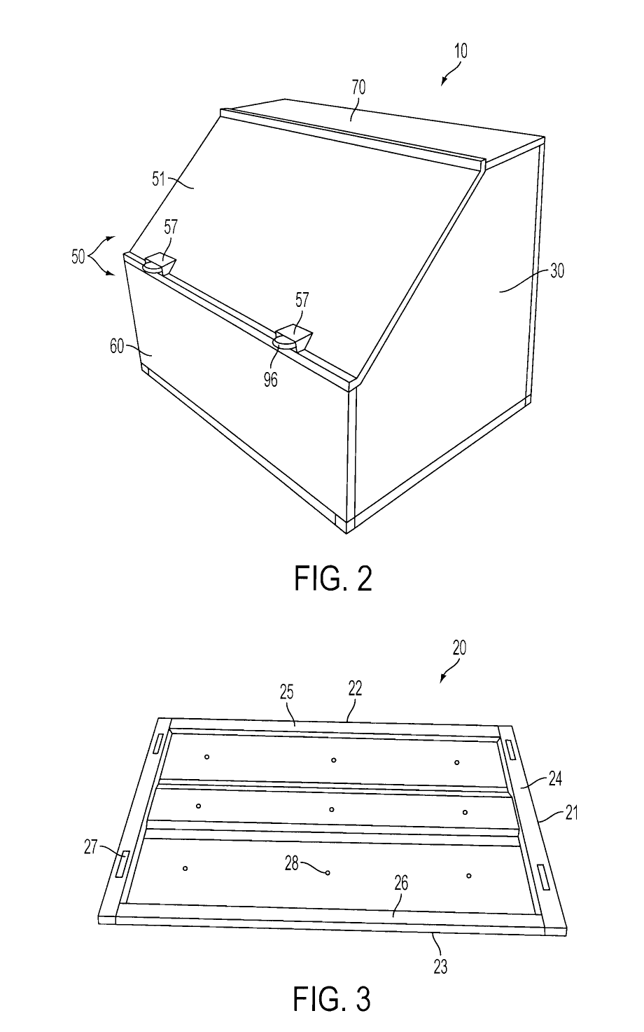

FIG. 1 shows the several components of an embodiment of the portable vault 10 disassembled and exploded. The embodiment shown in FIG. 1 has a base 20, a top 70, two end sides 30, a back side 40, and a door side 50 with a door 51 and door wall 60. In the embodiment shown in FIG. 1 door 51 is removable from top 70 where it is attached to form part of the door side 50 of portable vault 10 when portable vault 10 is assembled. FIG. 2 shows an assembled and locked portable vault 10, with top 70, an end side 30, and door side 50, including door 51 and door wall 60, visible. Lock covers 57 on door 51 provide protection to locks 96.

In the embodiments shown in FIG. 1 and FIG. 3, base 20 has two side edges 21, a back edge 22, and a front edge 23. Along each side edge 21 of base 20 runs a side rail 24. Along the back edge 22 of base 20 runs a back rail 25. Along the front edge 23 of base 20 runs a front rail 26. In side rail 24 are located assembly slots 27, which, as will be discussed below, assist in the assembly of this embodiment of portable vault 10.

Referring again to FIG. 1, it can be seen that on each of the end sides 30 are located side channels 38. Side channels 38 are sized so that they may fit over side rails 24 on base 20. In this embodiment, side channels 38 are shorter than the distance between back rail 25 and front rail 26 on base 20. This allows end side 30 to slide back and forth when end side 30 is placed on base 20 with side channel 38 on side rail 24.

The various walls making up sides of the several embodiments of portable vault 10 may have interlocking elements at or near their edges for connecting at or near the edges of walls making up neighboring sides. End sides 30 may have interlocking elements on or near edges such as edges 31, 32, 33, and 34 as shown on the several embodiments shown in the figures. Top 70 may have interlocking elements on or near its edges such as edges 71, 72, and 73 as shown on the several embodiments shown in the figures. Door wall 60 may have interlocking elements on or near its edges such as edges 61, 62, and 63 as shown on the several embodiments shown in the figures. Back 40 may have interlocking elements on or near its edges such as edges 41, 42, and 43 as shown on the several embodiments shown in the figures. In addition to interlocking elements on a wall making up one of its sides, embodiments having a base may have interlocking elements at or near its edges. For example, base 20 of the embodiments shown in FIG. 1, FIG. 3, and other figures may have interlock elements at or near its edges 21, 22, and 23.

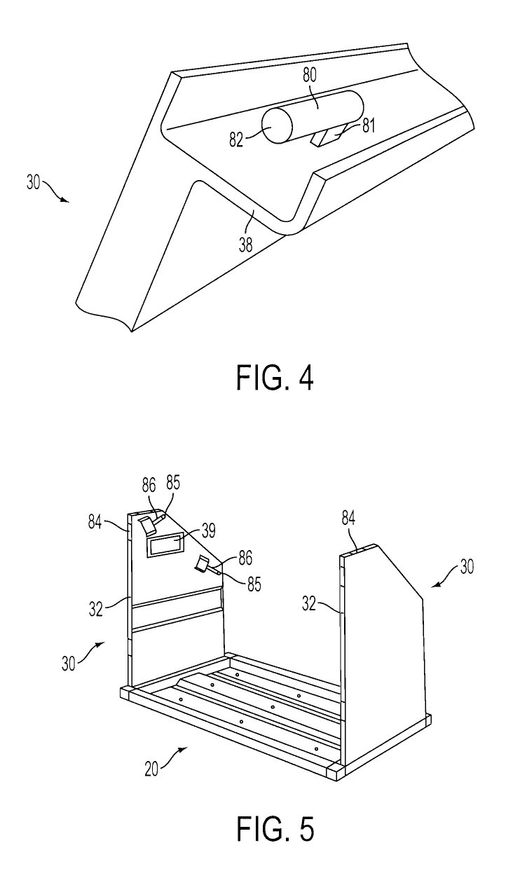

Referring now to FIG. 4, part of an inverted end side 30 is shown with the bottom of side channel 38 in view. On the bottom of side channel 38 is mounted assembly hook 80. Assembly hook 80 on side channel 38 is positioned to drop into slot 27 on side rail 24 on base 20. Slots 27 may be seen in FIG. 1 and FIG. 3. Assembly hook 80 drops into slot 27 in an initial position when end side 30 is set on side rail 24, and assembly hook 80 interlocks with side rail 24 when end side 30 is slid from an initial position to an engaged position on side rail 24.

Referring now to FIG. 5, both end sides 30 have been installed onto base 20 and the back of end sides 30 are shown. In FIG. 5, assembly slot 84 is visible on end sides 30. Also visible on the interior surface of one end side 30 are retention pins 85 and swing arms 86. As will be discussed later, retention pins 85 maintain the assembly of back side 40, door wall 60, and top 70 to end sides 30.

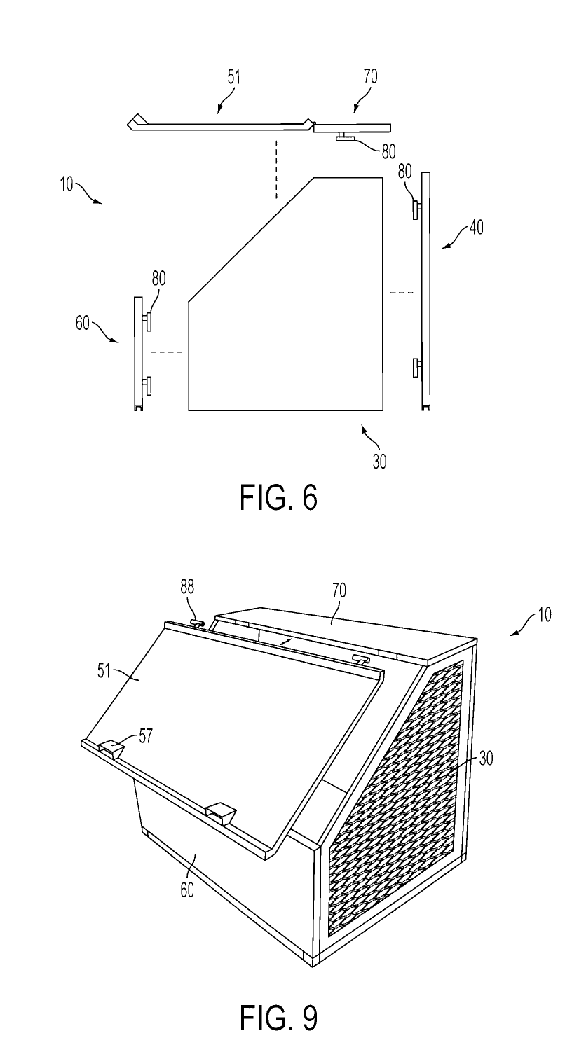

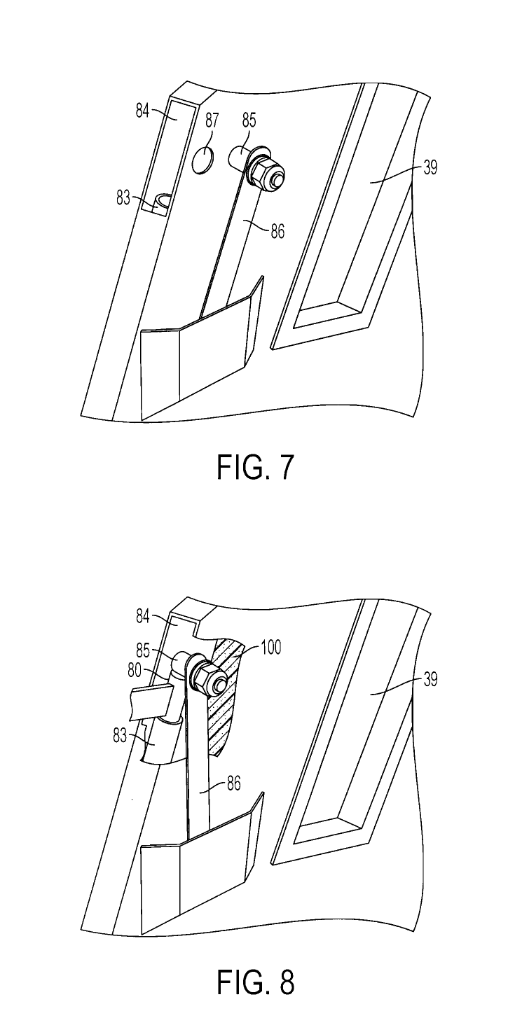

FIG. 6 is a side view of a partially assembled embodiment of a portable vault 10. In FIG. 6, back side 40, door wall 60, and top 70 are shown in position to be assembled to end sides 30. Similar to assembly hooks 80 on the bottom of side channels 38, back side 40, door wall 60, and top 70 have assembly hooks 80 attached to them. These assembly hooks 80 are positioned to match slots 84 in end sides 30 in an initial position. Referring now to FIG. 7 and FIG. 8, pin sleeves 83 located inside assembly slots 84 are positioned to receive pins 82 of assembly hooks 80. For example, back side 40 is pressed up against the back edges 32 of end sides 30 so that its assembly hooks 80 align with assembly slots 84 and then back side 40 is moved downwardly so that bottom channel 47 on back side 40 rests on back rail 25 on base 20 and pins 82 of assembly hooks 80 engage pin sleeves 83 in assembly slots 84. The assembly process for door wall 60 is essentially the same. The assembly of top 70 to end sides 30 is essentially the same, however, in this case, top 70 is slid horizontally once assembly hooks 80 are within assembly slot 84 to engage pins 82 with pin sleeves 83.

Referring now to FIG. 7, a method of maintaining assembly of one embodiment of portable vault 10 is shown in more detail. Assembly slot 84 is sized and located to accept assembly hook 80 as shown in FIG. 6 and FIG. 4. Retention pin 85 is mounted on swing arm 86 and can be moved into place to insert into retention aperture 87.

Referring now to FIG. 8, which shows a cut-away with an assembly hook 80 in place in assembly slot 84, it can be seen that retention pin 85 has been placed in retention aperture 87. The insertion of retention pin 85 into retention aperture 87 places retention pin 85 in a blocking position on the backside of assembly hook 80. This means that pin 82 on assembly hook 80 cannot be slid to disengage from pin sleeve 83 in the adjoining panel and removed from assembly slot 84 without the removal of retention pin 85. As shown in FIG. 5, retention pin 85 and swing arm 86 are located on the interior surface of end sides 30. This is the case for all retention pins 85 and swing arms 86 and means that the insertion and removal of retention pins 85 can only be accomplished by access to the interior of portable vault 10. When door 51 is closed, the interior of portable vault 10 is inaccessible.

In at least one embodiment of portable vault 10, each individual piece of portable vault 10 is of a weight that it can be carried by a single individual. However, when portable vault 10 is assembled, its total weight becomes such that it is extremely cumbersome to move. With the addition of the weight of contents being kept in portable vault 10, it becomes even more difficult to move.

In addition to the weight of the assembled portable vault 10 and its contents, some embodiments of portable vault 10 provide other means of making it difficult to remove an assembled portable vault 10 from its location. Referring again to FIGS. 1 and 3, apertures 28 may be seen in the central area of base 20. These apertures 28 pass entirely through base 20 and allow base 20 to be firmly affixed to the floor of the location where portable vault 10 is intended to be assembled and used. For example, base 20 may be placed at the desired location for portable vault 10 and screws driven through apertures 28 in base 20. Once base 20 is immovably attached to the desired location, the rest of portable vault 10 may be assembled to base 20. The apertures 28 in base 20 may have a standard spacing so that they match the standard spacing of floor joists, etc.

For example, the assembly of one embodiment of portable vault 10 may occur as now described. Base 20 is carried into the site, laid down on the floor, and screws driven through apertures 28 to fix base 20 in place. Next, a first end side 30 is set upon a respective side rail 24 on base 20 so that assembly hooks 80 fit into assembly slots 27 and then the end side 30 is slid until assembly hooks 80 engage side rails 24. This is repeated for the opposing end side 30. Next, back side 40 is pressed up against the back of end sides 30 so that its assembly hooks 80 insert into the assembly slots 84 on the back of end sides 30 and then back side 40 is adjusted downward until assembly hooks 80 on back side 40 engage assembly slots 84 in the back edges of end sides 30 and bottom channel 48 rests over back rail 25 on base 20. This places back side 40 in a blocking position behind end sides 30 so that they may not be slid and disengaged from side rails 24. Next, door wall 60 is similarly attached to front edges 33 of end sides 30. Retention pins 85 are then moved into location and inserted into retention apertures 87 to block the movement of assembly hooks 80 and retain door wall 60 in position. Next, top 70 with door 51 hingably attached to it is assembled to top edges 34 of end sides 30 with a similar sliding engagement of assembly hooks 80 in assembly slots 84 until pins 82 of assembly hooks 80 engage pin sleeves 83 in end sides 30. Again, retention pins 85 are moved into place to block the movement of top 70. Once top 70 is installed, it serves to block the removal of back side 40. In the embodiment now being described, the order of assembly of top 70 and door wall 60 may be changed. Door 51 may be closed down upon the door edges 35 of end sides 30 and the door edge 63 of door wall 60. Lock rings 69 on door wall 60 and lock apertures 58 on door 51 (see FIG. 11) allow door 51 to be locked down upon door wall 60. When door 51 is closed, lock rings 69 on door wall 60 protrude through lock apertures 58 on door 51. A lock 96 may be inserted into each lock ring 69 to hold door 51 in place. Lock covers 57 on door 51 protect locks 96 from tampering as shown in FIG. 2. Once door 51 is locked closed, the interior of portable vault 10 is inaccessible and retention pins 85 at the various locations are inaccessible and prevent the disassembly of portable vault 10.

Alternative embodiments may employ alternative methods of fixing a portable vault 10 to its assembly site. In FIG. 1 apertures 97 and chain apertures 98 in back side 40 may be used to fix portable vault 10 to its site. Apertures 97 in back side 40 may be used similarly to apertures 28 in base 20. Back side 40 may be fixed to a nearby surface with screws through aperture 97 in back side 40. Chain apertures 98 allow a chain to be used to secure portable vault 10 to a post or similar fixed object or to objects having great mass. Also shown in FIG. 1 is utility aperture 99 which may be used to pass electrical cords for chargers or provide access for other purposes.

FIG. 9 shows an embodiment of a portable vault 10 where door panel 51 and top 70 may be installed individually in the assembly process. In FIG. 9, door 51 is removably hinged to top 70. This removable hinge interface between top 70 and door 51 is only accessible from the interior of portable vault 10 and when door 51 is locked closed, disengageable hinge 88 is inaccessible. Along with the locking of door 51 closed, the interaction of door 51 and end sides 30 provide additional immobilization of door 51.

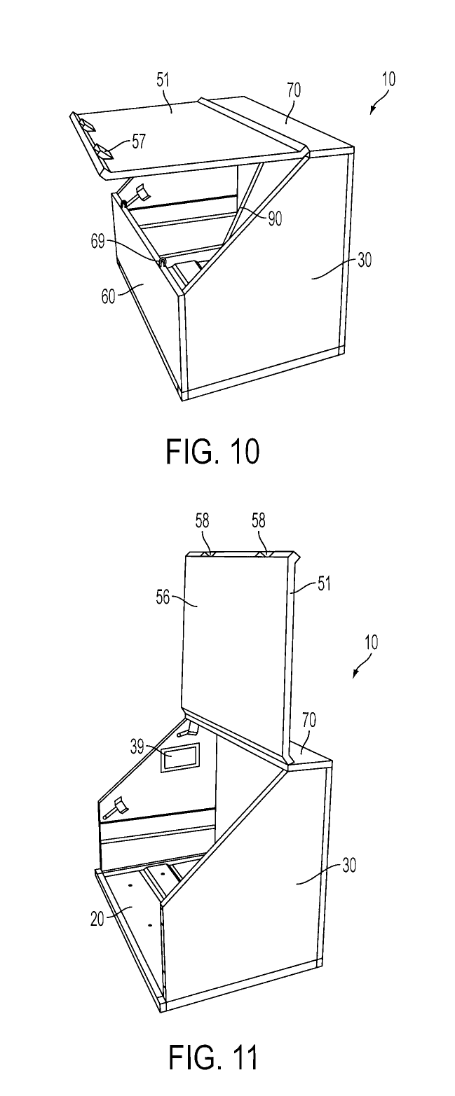

For ease of use, door 51 may be opened to various positions to allow access to the interior of portable vault 10. FIGS. 10 and 11 show door 51 opened to two different positions. In FIG. 11, door 51 is opened to an essentially vertical position. In FIG. 10, door 51 is opened to an essentially horizontal position and is maintained there by prop 90 which is pivotally attached to either end side 30 or door 51 and engaged in a notch in the opposing respective panel. When door 51 is placed in a horizontal position, it provides somewhat limited access to interior of portable vault 10, but it provides a large horizontal surface which may be used for a work surface, writing surface, or merely a catch-all.

Returning to FIG. 11, in addition to door 51 being raised to a vertical position for access to the interior, door wall 60 is also removed. This gives even greater access to the interior of portable vault 10, especially for very large items which may be rolled into portable vault 10. For example, an air compressor could be rolled into portable vault 10, door wall 60 could be replaced onto portable vault 10, and door 51 lowered and locked into place. This capability provides additional utility to this embodiment of portable vault 10.

Referring to FIG. 9, in the embodiment of portable vault 10 shown, end side 30 is made of expanded steel. The use of expanded steel provides visibility and/or air flow. Of course, more than one element of portable vault 10 can be made from expanded steel depending on what is needed or desired. In some embodiments, only parts of an element may be made of expanded steel.

Referring to FIG. 8, the cutaway view of FIG. 8 reveals a surface 100 interior to the wall. This surface 100 may be foam or other material within the wall. This material can provide additional structural rigidity for a wall constructed of metal sheets with space between them. Additionally the foam may provide heat or sound insulation for some embodiments of portable vaults. Also apparent in FIG. 8 as well as FIG. 7 and other figures showing other embodiments of portable vault 10 are recesses 39. Recesses 39 can be used as handles to carry wall elements used to construct the sides of portable vault 10.

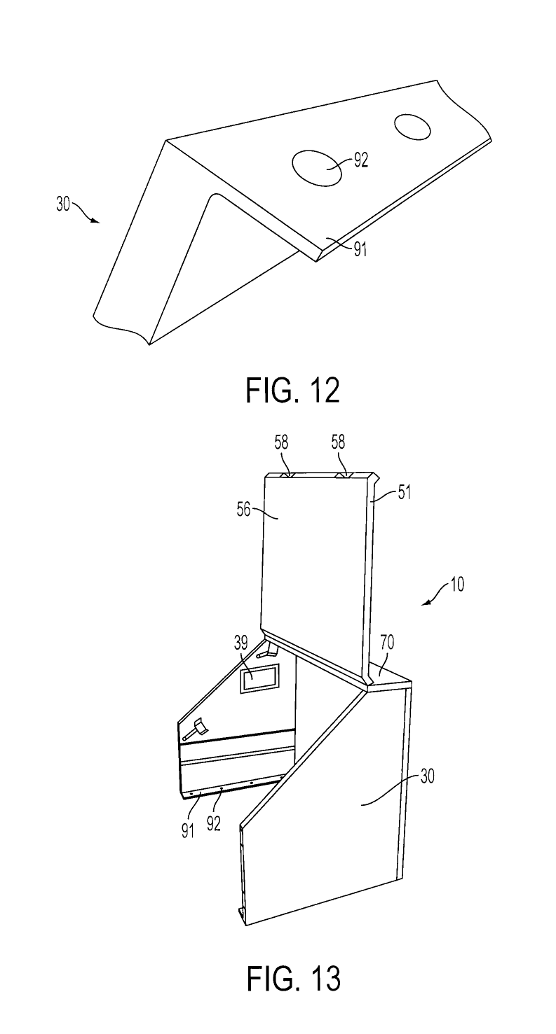

FIG. 12 shows a perspective view of parts of the bottom of a panel of an embodiment of the invention. Plate 91 on the bottom of the panel of FIG. 12 has apertures 92 through it. These apertures 92 may be used to fix the panel to the site where portable vault 10 is to be assembled.

FIG. 13 shows an embodiment of portable vault 10 where a panel such as that shown in FIG. 12 has been used to construct the wall of end sides 30. End sides 30 may be attached to the site where portable vault 10 is assembled by driving screws through apertures 92.

It should further be stressed that further utility for the portable vault can sometimes be achieved by co-joining one or more of the portable vaults together to form one unitary storage bin, larger in size. For example, the specific portable vault construction set forth in FIGS. 1 through 3 can be modified by co-joining two such vaults together. Accordingly, the otherwise separate vaults can be arranged back to back.

In such arrangement, if the two respective back panels (40) are removed, the resultant space for the combined co-joined vault is doubled. Alternatively, back panels (40) may not be removed. In this arrangement, the resulting vault is a co-joined unit but with separate storage compartments, each accessible by its own door. These doors can be separately locked, and serves the utility of providing separately secure compartments for unrelated work crews, etc.

It is further envisioned that a pair of co-joined portable vaults, co-joined back to back may be further co-joined with another pair of back-to-back portable vaults, by connecting them on the side. Accordingly, the resultant arrangement results in even more storage capability that is even more immobile. Yet, the entire assembly may also be quickly disassembled when desired

While several embodiments of the present invention of a portable vault have been described in detail, the specifics of the embodiments shown and described should not be taken as limiting the scope of the invention. Many more embodiments are possible within the scope of the invention. For example, the invention is not limited to having the same number of sides as the embodiments specifically shown and described. Portable vaults could be constructed having one or more sides. Similarly, the sides of an embodiment could have more than one wall making up a side, and multiple panels could be used to construct a wall. Angles could also exist between walls or panels making up a side, and hinges could be employed between walls in addition to the hinge between a door and its supporting element. The interior of a portable vault may have additional features such as shelves. Spring loaded pins or other mechanisms may be used to maintain the assembly of portable vault 10.

1. A portable vault comprising:
multiple panels being modularly interconnectable with each other to construct said portable vault,
wherein each said panel is portable by a single individual, and wherein;
at least one of said multiple panels functions as a door providing access to the interior of said portable vault, and disassembly of the portable vault can only be achieved by access through said door.

2. The portable vault of claim 1 further comprising:
means for fixing said portable vault to the site where it is assembled for use.

3. The portable vault of claim 1 further comprising:
a base panel having apertures therethrough for attaching said base panel to the floor of the location where said portable vault is assembled.

4. The portable vault of claim 1, wherein:
said multiple panels are modularly interconnectable at their edges.

5. The portable vault of claim 1, wherein:
at least one set of at least two of said panels is hingably connected to each other.

6. The portable vault of claim 1, wherein;
said at least one of said multiple panels functions as a door by swinging in a substantially vertical direction.

7. The portable vault of claim 1 wherein;
said at least one of said multiple panels functioning as a door comprises an entire side of said portable vault.

8. The portable vault of claim 1 wherein;
at least one of said panels is of mesh construction.

9. The portable vault of claim 1, wherein:
said portable vault is of frameless shell construction.

10. The portable vault of claim 1, wherein:
said portable vault is conjoined with a second portable vault.

11. The portable vault of claim 10, wherein:
said portable vault and said second portable vault each have a door.
